(19) United States
(12) Patent Application Publication
(10) Pub. No.: US 2025/0118829 A1
(43) Pub. Date: Apr. 10, 2025

(54) THERMAL MANAGEMENT AND VENTING SYSTEMS AND ASSOCIATED METHODS FOR TRACTION BATTERY PACKS

(71) Applicant: FORD GLOBAL TECHNOLOGIES, LLC, Dearborn, MI (US)

(72) Inventor: Xiaogang ZHANG, Novi, MI (US)

(21) Appl. No.: 18/483,754

(22) Filed: Oct. 10, 2023

(51) Int. Cl. H01M 10/6568; B60L 50/60; B60L 58/26; H01M 10/613; H01M 10/625; H01M 10/63; H01M 10/653; H01M 10/6554; H01M 10/6556; H01M 50/209; H01M 50/258; H01M 50/342; H01M 50/358

(52) U.S. Cl. CPC H01M 10/6568; B60L 50/60; B60L 58/26; H01M 10/613; H01M 10/625; H01M 10/63; H01M 10/653; H01M 10/6554; H01M 10/6556; H01M 50/209; H01M 50/258; H01M 50/3425; H01M 50/358; H01M 2200/20; H01M 2220/20

(57) ABSTRACT

Thermal management and venting systems are provided for managing thermal energy levels of traction battery packs. An exemplary thermal management and venting system may be configured to control a flow of a cooling fluid through an interior volume of a battery module based on a temperature of a cooling fluid exiting a heat exchanger plate of the traction battery pack. The proposed systems are therefore capable of more quickly and efficiently reducing temperatures of vent gases and hot particulates by mixing the vent gases with the cooling fluid, thereby substantially eliminating vent gas combustion and thermal propagation during a battery thermal event.

### TECHNICAL FIELD

This disclosure relates generally to electrified vehicle traction battery packs, and more particularly to thermal management and venting systems for managing thermal energy levels within traction battery packs.

### BACKGROUND

An electrified vehicle includes a traction battery pack for powering electric machines and other electrical loads of the vehicle. The traction battery pack includes a plurality of battery cells and various other battery internal components that support electric vehicle propulsion.

### SUMMARY

A traction battery pack according to an exemplary aspect of the present disclosure includes, among other things, a first battery module that includes a plurality of battery cells arranged within a first interior volume, a heat exchanger plate positioned in thermal contact with the plurality of battery cells, a first intake manifold fluidly connected to the first interior volume, a second intake manifold fluidly connected to the heat exchanger plate, a flow control valve configured to selectively control a flow of a cooling fluid to at least one of first intake manifold or the second intake manifold, and a control module programmed to control a position of the flow control valve based on a temperature of the cooling fluid exiting the heat exchanger plate.

In a further non-limited embodiment of the foregoing traction battery pack, a second battery module includes a second interior volume that is fluidly isolated from the first interior volume.

In a further non-limiting embodiment of either of the foregoing traction battery packs, the first intake manifold is fluidly connected to the second interior volume.

In a further non-limiting embodiment of any of the foregoing traction battery packs, a first intake runner fluidly connects the first intake manifold to the first interior volume. A second intake runner fluidly connects the first intake manifold to the second interior volume.

In a further non-limiting embodiment of any of the foregoing traction battery packs, a first exhaust manifold fluidly connects to the first interior volume by a first exhaust runner. A second exhaust manifold fluidly connects to the second interior volume by a second exhaust runner.

In a further non-limiting embodiment of any of the foregoing traction battery packs, a first intake runner fluidly connects the first intake manifold to the first interior volume.

In a further non-limiting embodiment of any of the foregoing traction battery packs, a pressure activated valve is installed within the first intake runner.

In a further non-limiting embodiment of any of the foregoing traction battery packs, the control module is programmed to command the flow control valve to a first position for directing the flow of the cooling fluid through the second intake manifold and not the first intake manifold when the temperature of the cooling fluid exiting the heat exchanger plate is less than a predefined temperature threshold.

In a further non-limiting embodiment of any of the foregoing traction battery packs, the control module is programmed to command the flow control valve to a second position for directing the flow of the cooling fluid through the first intake manifold and not the second intake manifold when the temperature of the cooling fluid exiting the heat exchanger plate is greater than or equal to the predefined temperature threshold.

In a further non-limiting embodiment of any of the foregoing traction battery packs, the control module is programmed to command the flow control valve to a position for dividing the flow of the cooling fluid between the first intake manifold and the second intake manifold when the temperature of the cooling fluid exiting the heat exchanger plate is greater than or equal to the predefined temperature threshold.

In a further non-limiting embodiment of any of the foregoing traction battery packs, a temperature sensor is positioned within or near a cooling fluid outlet of the heat exchanger plate and is configured to sense the temperature.

In a further non-limiting embodiment of any of the foregoing traction battery packs, a thermal interface material is configured to maintain the thermal contact between the plurality of battery cells and the heat exchanger plate.

In a further non-limiting embodiment of any of the foregoing traction battery packs, a first exhaust manifold is fluidly connected to the first interior volume by a first exhaust runner.

In a further non-limiting embodiment of any of the foregoing traction battery packs, the first exhaust manifold is configured to expel the cooling fluid and a battery vent byproduct from the first interior volume during a battery thermal event.

In a further non-limiting embodiment of any of the foregoing traction battery packs, the second intake manifold is fluidly connected to an internal cooling circuit of the heat exchanger plate.

A traction battery pack according to another exemplary aspect of the present disclosure includes, among other things, a first battery module that includes a plurality of battery cells arranged within a first interior volume, a first cooling fluid inlet configured to receive a first cooling fluid, a first intake manifold fluidly connected to the first interior volume and configured to receive the first cooling fluid from the first cooling fluid inlet, a second cooling fluid inlet configured to receive a second cooling fluid, a heat exchanger plate positioned in thermal contact with the plurality of battery cells and configured to receive the second cooling fluid from the second cooling fluid inlet, and a control module programmed to control a flow of the first cooling fluid from the first cooling fluid inlet into the first intake manifold based on a temperature of the second cooling fluid exiting the heat exchanger plate.

In a further non-limiting embodiment of the foregoing traction battery pack, the first cooling fluid is a dielectric fluid and the second cooling fluid is a coolant.

In a further non-limiting embodiment of either of the foregoing traction battery packs, a second battery module includes a second interior volume that is fluidly isolated from the first interior volume.

In a further non-limiting embodiment of any of the foregoing traction battery packs, the control module is programmed to command the flow of the first cooling fluid into the first intake manifold when the temperature of the second cooling fluid exiting the heat exchanger plate is greater than or equal to a predefined temperature threshold.

In a further non-limiting embodiment of any of the foregoing traction battery packs, the control module is programmed to prevent the flow of the first cooling fluid into the first intake manifold when the temperature of the second cooling fluid exiting the heat exchanger plate is less than the predefined temperature threshold.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle.

FIG. 2 illustrates a thermal management and venting system for a traction battery pack.

FIG. 3 schematically illustrates operation of the thermal management and venting system of FIG. 2 during a first operation mode.

FIG. 4A schematically illustrates operation of the thermal management and venting system of FIG. 2 during a second operation mode.

FIG. 4B schematically illustrates operation of the thermal management and venting system of FIG. 2 during a third operation mode.

FIG. 5 illustrates another exemplary thermal management and venting system for a traction battery pack.

FIG. 6 illustrates yet another exemplary thermal management and venting system for a traction battery pack.

### DETAILED DESCRIPTION

This disclosure details thermal management and venting systems for managing thermal energy levels of traction battery packs. An exemplary thermal management and venting system may be configured to control a flow of a cooling fluid through an interior volume of a battery module based on a temperature of a cooling fluid exiting a heat exchanger plate of the traction battery pack. The proposed systems are capable of more quickly and efficiently reducing temperatures of vent gases and hot particulates by mixing the vent gases with the cooling fluid, thereby substantially eliminating vent gas combustion and thermal propagation during a battery thermal event. These and other features are discussed in greater detail in the following paragraphs of this detailed description.

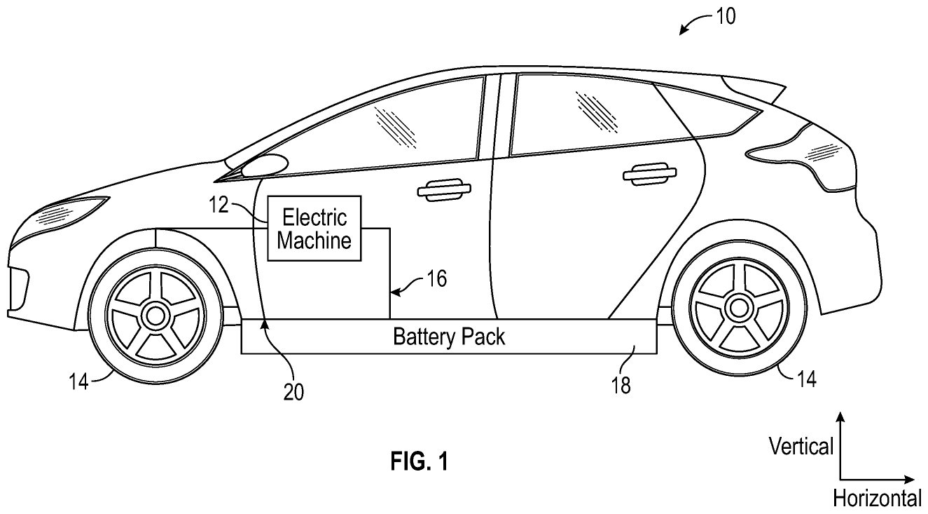

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a car. However, the electrified vehicle 10 could alternatively be a sport utility vehicle (SUV), a van, a pickup truck, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component or system.

In the illustrated embodiment, the electrified vehicle 10 is a full electric vehicle propelled solely through electric power, such as by one or more electric machines 12, without assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack 18. The traction battery pack 18 is an exemplary electrified vehicle battery. The traction battery pack 18 may be a high voltage traction battery pack assembly that includes a plurality of battery cells capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 may be secured to an underbody 20 of the electrified vehicle 10. However, the traction battery pack 18 could be located elsewhere on the electrified vehicle 10 within the scope of this disclosure.

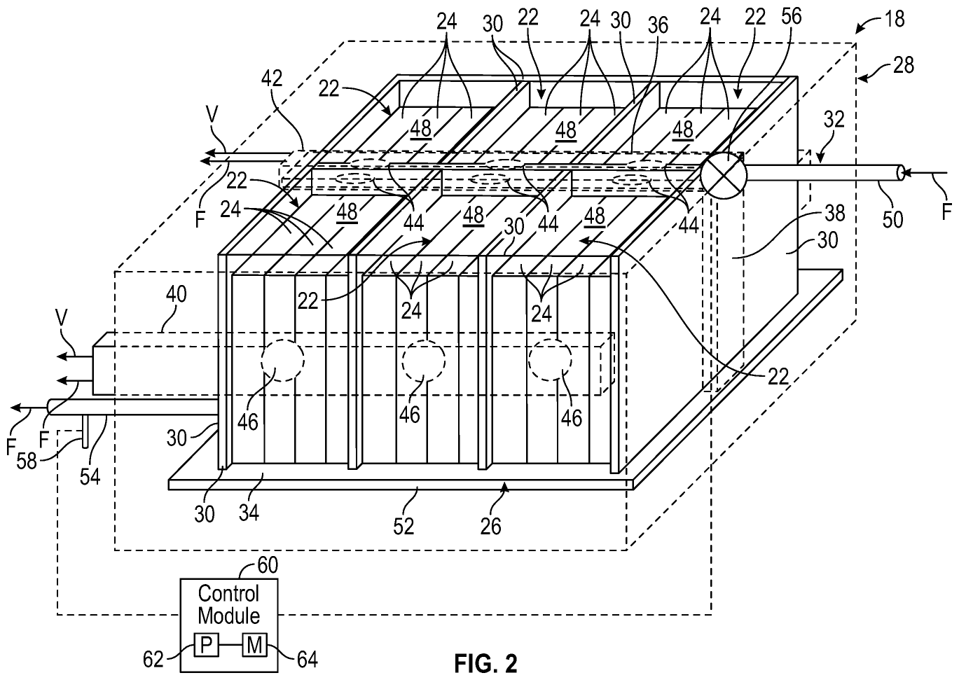

FIG. 2 illustrates additional details associated with the traction battery pack 18 of the electrified vehicle 10 of FIG. 1. The traction battery pack 18 may include a plurality of battery modules 22 (e.g., battery assemblies or groupings of rechargeable battery cells 24) capable of outputting electrical power to power the electric machine 12 and/or other electrical loads of the electrified vehicle 10.

The battery cells 24 may be stacked side-by-side along a stack axis to construct a grouping of battery cells 24, sometimes referred to as a “cell stack.” The total number of battery modules 22 and battery cells 24 provided within the traction battery pack 18 is not intended to limit this disclosure.

In an embodiment, the battery cells 24 of each battery module 22 are prismatic, lithium-ion cells. However, battery cells having other geometries (cylindrical, pouch, etc.), other chemistries (nickel-metal hydride, lead-acid, etc.), or both could alternatively be utilized within the scope of this disclosure.

The battery modules 22 may be arranged in on or more rows or banks inside the traction battery pack 18. In an embodiment, the traction battery pack 18 includes six battery modules 22, and each battery module 22 includes four battery cells 24 (for a total of twenty-four battery cells 24). However, other configurations are possible, and therefore the traction battery pack 18 could include a greater or fewer number of battery modules 22 and battery cells 24 within the scope of this disclosure.

The battery modules 22 and various other battery internal components (e.g., bussed electrical center, battery electric control module, wiring, connectors, etc.) may be housed inside of an enclosure assembly 28 of the traction battery pack 18. Although shown schematically, the enclosure assembly 28 could embody a single-piece design or multi-piece design (e.g., enclosure cover and enclosure tray that are joined together to establish an interior for housing the battery modules 22). The size, shape, and overall configuration of the enclosure assembly 28 is not intended to limit this disclosure. In an embodiment, the enclosure assembly 28 provides a sealed enclosure around the battery modules 22 and other battery internal components of the traction battery pack 18. The enclosure assembly 28 therefore provides outermost surfaces of the traction battery pack 18.

Each battery module 22 is compartmentalized and is therefore fluidly isolated from the other battery modules 22 of the traction battery pack 18. Accordingly, gases, effluent particles, and/or other vent byproducts vented by one of the battery cells 24 of one of the battery modules 22 cannot flow directly to another of the battery modules 22.

Each battery module 22 may be separated from the other battery modules 22 of the traction battery pack 18. For example, the battery modules 22 may be separated from one another by compartmentalization panels 30 that establish housings for separating each of the battery modules 22. The compartmentalization panels 30 may be configured to block the transfer of thermal energy from one battery module 22 to another. The compartmentalization panels 30 may further provide a desired level of compressibility for more easily positioning the battery modules 22 within the enclosure assembly 28. The compartmentalization panels 30 may be made of any suitable insulating material (e.g., mica, aerogels, or any other suitable material or combinations of materials).

The traction battery pack 18 may additionally include a thermal management and venting system 32. As further explained below, the thermal management and venting system 32 may be configured to thermally manage the battery modules 22 and further to manage battery vent byproducts V during battery thermal events. A battery thermal event may occur, for example, during over-charging conditions, over-discharging conditions, or other conditions and can cause one or more of the battery cells 24 to expel the battery vent byproducts V, which may include gases, effluent particles, and/or other vent byproducts.

The thermal management and venting system 32 may include one or more heat exchanger plates 26. Each heat exchanger plate 26 may be configured as a cold plate for conducting heat out of the battery cells 24 during normal operation of the traction battery pack 18. In an embodiment, the battery modules 22 may share a common heat exchanger plate 26. However, each battery module 22 could include its own dedicated heat exchanger plate 26 within the scope of this disclosure.

A thermal interface material 34 may be provided between the battery cells 24 of each battery module 22 and the heat exchanger plate 26. The thermal interface material 34 may be configured to fixedly secure the battery cells 24 in place relative to the heat exchanger plate 26. In an embodiment, bottom-facing surfaces of the battery cells 24 are in direct contact with the thermal interface material 34. However, other configurations are contemplated within the scope of this disclosure.

The thermal interface material 34 may be further configured to maintain thermal contact between the battery cells 24 and the heat exchanger plate 26, thereby facilitating thermal conductivity between these neighboring components during heat transfer events. Heat conducted from the battery cells 24 to the heat exchanger plate 26 may then be carried away from the battery cells 24, such as by a cooling fluid F that may be circulated inside the heat exchanger plate 26. In an embodiment, the cooling fluid F is a conventional type of coolant mixture such as water mixed with ethylene glycol. However, other coolants, including gases, are also contemplated within the scope of this disclosure.

The thermal management and venting system 32 may additionally include a first intake manifold 36, a second intake manifold 38, a first exhaust manifold 40, a second exhaust manifold 42, a plurality of intake runners 44, and a plurality of exhaust runners 46. The first intake manifold 36 may extend horizontally over top of the battery modules 22 along a centerline between adjacent rows of the battery modules 22, and the second intake manifold 38 may extend vertically along one of the compartmentalization panels 30 that is located on an outboard side/end of the grouping of battery modules 22. However, other arrangements are contemplated within the scope of this disclosure. Vertical and horizontal, for purposes of this disclosure, are with reference to ground in an ordinary orientation of the electrified vehicle 10 during operation.

The first exhaust manifold 40 and the second exhaust manifold 42 may each extend horizontally along another one of the compartmentalization panels 30 that is located on an outboard side/end of the grouping of battery modules 22. In some implementations, at least a portion each of the first and second exhaust manifolds 40, 42 may extend outside of the enclosure assembly 28 of the traction battery pack 18. A first portion (e.g., a first row) of the battery modules 22 may be fluidly connected to the first exhaust manifold 40, and a second portion (e.g., a second row) of the battery modules 22 may be fluidly connected to the second exhaust manifold 42.

The intake runners 44 may be fluidly connected to the first intake manifold 36, and each exhaust runner 46 may be fluidly connected to either the first exhaust manifold 40 or the second exhaust manifold 42. Each intake runner 44 and each exhaust runner 46 may further be fluidly connected to an interior volume 48 of one of the battery modules 22. The intake runners 44 and exhaust runners 46 may be configured as multiple aligned holes formed through adjacent components or as pipes or tubes that connect between the adjacent components within the scope of this disclosure.

The first intake manifold 36 and the second intake manifold 38 may each be fluidly connected to a cooling fluid inlet 50 that is configured to receive the cooling fluid F, such as from a reservoir (not shown), for example. In some implementations, at least a portion of the cooling fluid inlet 50 may extend to a location outside of the enclosure assembly 28.

During some operating modes, the cooling fluid F may be selectively communicated through the first intake manifold 36 before being separated into the multiple intake runners 44. The cooling fluid F may then separately enter the interior volume 48 of each battery module 22 through the intake runners 44. The cooling fluid F may pick up heat from the battery cells 24 through convective heat transfer as it flows through the interior volume 48 of each battery module 22, thereby carrying away excessive heat and stabilizing the temperatures of the battery cells 24. The cooling fluid F may exit each battery module 22 through the exhaust runners 46 before merging within the first exhaust manifold 40 or the second exhaust manifold 42. During battery thermal events, battery vent byproducts V may also be expelled from one or more of the battery modules 22 via the first exhaust manifold 40 and/or the second exhaust manifold 42.

During other operating modes, the cooling fluid F may be selectively communicated through the second intake manifold 38, which is fluidly connected to the heat exchanger plate 26, instead of the first intake manifold 36. The cooling fluid F may flow through the second intake manifold 38 and then enter an internal cooling circuit 52 of the heat exchanger plate 26. The cooling fluid F may pick up heat that is generated within the battery cells 24 as it circulates through the internal cooling circuit 52 prior to being expelled from the heat exchanger plate 26 through a cooling fluid outlet 54.

The thermal management and venting system 32 may further include a flow control valve 56, a temperature sensor 58, and a control module 60. The flow control valve 56 may be fluidly connected to the cooling fluid inlet 50, the first intake manifold 36, and the second intake manifold 38 and may be configured to control the flow of the cooling fluid F permitted to enter each of the first intake manifold 36 and the second intake manifold 38. The flow control valve 56 may be a multi-position solenoid valve (here, a three-way valve) or any other suitable type of valve.

The temperature sensor 58 may be configured to sense the temperature of the cooling fluid F. In an embodiment, the temperature sensor 58 is provided within or near the cooling fluid outlet 54 of the heat exchanger plate 26. The temperature sensor 58 may therefore be arranged to sense the temperature of the cooling fluid F exiting the heat exchanger plate 26.

The control module 60 may be operably connected to the flow control valve 56 and the temperature sensor 58 and may be programmed to control operations of the thermal management and venting system 32. The control module 60 may include both hardware and software and could be part of an overall vehicle control system, such as a vehicle system controller (VSC), or could alternatively be a stand-alone controller or collection of controllers that are separate from the VSC. It should therefore be understood that the control module 60 and one or more additional controllers operably coupled thereto can collectively be referred to as a “control module” within the scope of this disclosure.

The control module 60 may be programmed with executable instructions for interfacing with and commanding operation of various components of the thermal management and venting system 32 as part of an overall control strategy for controlling the flow path of the cooling fluid F. The control module 60 may include a processor 62 and non-transitory memory 64 for executing the various control strategies and modes associated with the thermal management and venting system 32. The processor 62 may be a custom made or commercially available processor, a central processing unit (CPU), or generally any device for executing software instructions. The memory 64 may include any one or combination of volatile memory elements and/or nonvolatile memory elements. The processor 62 may be operably coupled to the memory 64 and may be configured to execute one or more programs stored in the memory 64 based on the various inputs received from other devices (e.g., the temperature sensor 58) associated with the thermal management and venting system 32.

The temperature sensor 58 may be configured to periodically provide input signals to the control module 60 that are indicative of the temperature of the cooling fluid F exiting the heat exchanger plate 26. In response to receiving the input signals, the control module 60 may control a position of the flow control valve 56 in order to achieve a desired flow path of the cooling fluid F.

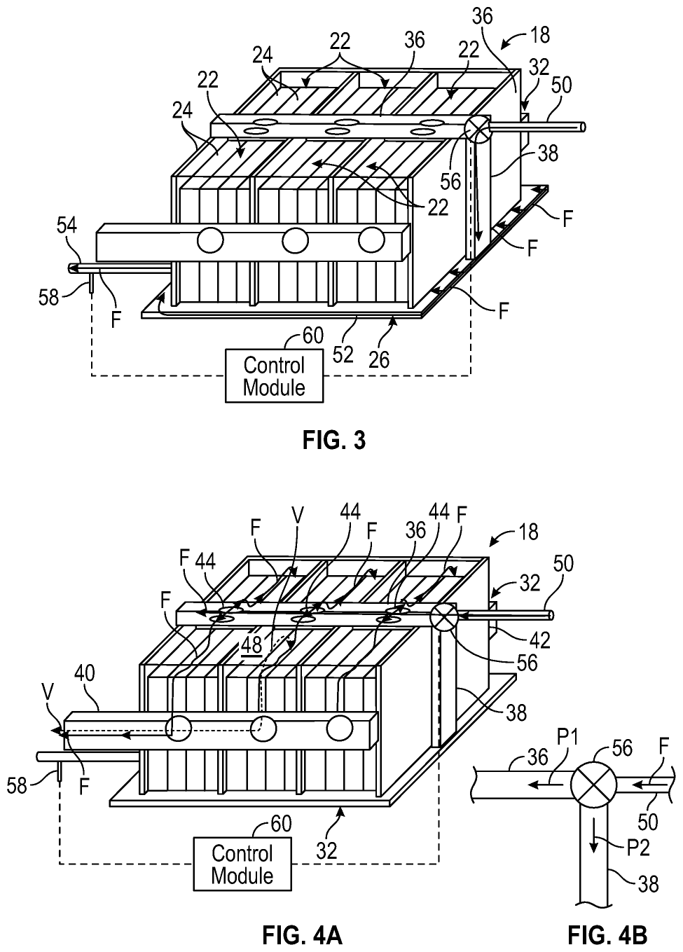

For example, a first operation mode that can be commanded by the control module 60 is schematically illustrated in FIG. 3. The first operation mode may be considered a default mode of the thermal management and venting system 32 and can occur when the temperature input signals from the temperature sensor 58 indicate a temperature of the cooling fluid F that is below a predefined temperature threshold (e.g., about 60 degrees C.). When this occurs, the control module 60 may command the flow control valve 56 to a first position for directing the cooling fluid F from the cooling fluid inlet 50 into the second intake manifold 38. The cooling fluid F may therefore flow through the internal cooling circuit 52 of the heat exchanger plate 26 for thermally managing the battery cells 24 during normal operating conditions of the traction battery pack 18. Flow of the cooling fluid F is blocked from entering the first intake manifold 36 by the flow control valve 56 during the first operation mode.

A second operation mode that can be commanded by the control module 60 is schematically illustrated in FIG. 4A. The second operation mode may be specifically adapted for responding to a battery thermal event that could occur within one or more of the battery modules 22. For example, when the temperature input signals from the temperature sensor 58 indicate a temperature that is greater than or equal to the predefined temperature threshold (e.g., about 60 degrees C.), the control module 60 may command the flow control valve 56 to a second position for directing the cooling fluid F from the cooling fluid inlet 50 into the first intake manifold 36. The cooling fluid F may therefore flow through the intake runners 44 and then into the interior volume 48 of each battery module 22 for quickly and efficiently carrying away excessive heat and stabilizing the temperatures of the battery cells 24 and expelling battery vent byproducts V from one or more of the battery modules 22 (e.g., through the first exhaust manifold 40 and/or the second exhaust manifold 42) that are experiencing the battery thermal event. Flow of the cooling fluid F is blocked from entering the second intake manifold 38 by the flow control valve 56 during the second operation mode.

A third operation mode that can be commanded by the control module 60 is schematically illustrated in FIG. 4B. The third operation mode may be specifically adapted for responding to a battery thermal event that could occur within one or more of the battery modules 22. For example, when the temperature input signals from the temperature sensor 58 indicate a temperature that is that is greater than or equal to the predefined temperature threshold (e.g., about 60 degrees C.), the control module 60 may command the flow control valve 56 to a third position for dividing a flow of the cooling fluid F from the cooling fluid inlet 50 into a first portion P1 that is directed into the first intake manifold 36 and a second portion P2 that is simultaneously directed into the second manifold 38. In an embodiment, the first portion P1 is about 30% of the cooling fluid F, and the second portion is about 70% of the cooling fluid F. However, other amounts are possible. The first portion P1 of the cooling fluid F may therefore flow through the intake runners 44 and then into the interior volume 48 of each battery module 22 for quickly and efficiently carrying away excessive heat and stabilizing the temperatures of the battery cells 24 and expelling battery vent byproducts V from one or more of the battery modules 22 (e.g., through the first exhaust manifold 40 and/or the second exhaust manifold 42) that are experiencing the battery thermal event, and the second portion P2 of the cooling fluid F may simultaneously flow through the internal cooling circuit 52 of the heat exchanger plate 26 for thermally managing the battery cells 24 during the third operation mode.

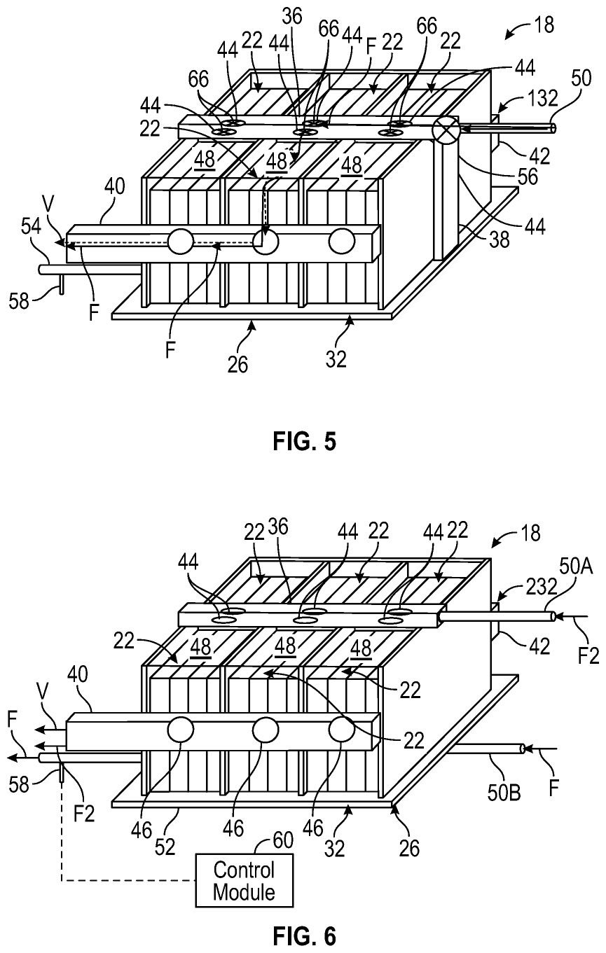

FIG. 5 illustrates another exemplary thermal management and venting system 132 that can be employed by the traction battery pack 18. The thermal management and venting system 132 is similar to the thermal management and venting system 32 described above. However, in this embodiment, a pressure activated valve 66 may be installed within each of the intake runners 44 that fluidly connect the first intake manifold 36 to each of the battery modules 22.

Each pressure activated valve 66 may be configured to rupture to fluidly connect the interior volume 48 of the battery module 22 experiencing a battery thermal event to the first intake manifold 36 when a pressure within the battery module 22 exceeds a predefined pressure threshold (e.g., about 1 psi). When such a condition occurs, all of the cooling fluid F may be delivered directly to the battery module(s) 22 experiencing the battery thermal event for maximizing cooling performance and more quickly expelling the battery vent byproducts V from the battery module 22 (e.g., through the first exhaust manifold 40 and/or the second exhaust manifold 42), and the remaining battery modules 22 that are not experiencing a battery thermal event would receive none of the cooling fluid F.

FIG. 6 illustrates yet another exemplary thermal management and venting system 232 that can be employed by the traction battery pack 18. In this embodiment, the features of the flow control valve and the second intake manifold are removed from the thermal management and venting system 232. A first cooling fluid inlet 50A may be fluidly connected to the first intake manifold 36, and a second cooling fluid inlet 50B may be fluidly connected to the internal cooling circuit 52 of the heat exchanger plate 26.

During a first operation mode that can occur when the temperature input signals from the temperature sensor 58 indicate a temperature of the cooling fluid F that is below a predefined temperature threshold (e.g., about 60 degrees C.), the control module 60 may continue to command the flow of the cooling fluid F from the second cooling fluid inlet 50B into the heat exchanger plate 26. The cooling fluid F may therefore flow through the internal cooling circuit 52 of the heat exchanger plate 26 for thermally managing the battery cells 24 during normal operating conditions of the traction battery pack 18. Fluid flow through the first intake manifold 36 is prevented during the first operation mode.

During a second operation mode that can occur when the temperature input signals from the temperature sensor 58 indicate a temperature that is greater than or equal to the predefined temperature threshold (e.g., about 60 degrees C.), the control module 60 may command the flow of another cooling fluid F2 (e.g., a dielectric fluid) for directing the cooling fluid F2 from the first cooling fluid inlet 50A into the first intake manifold 36. The cooling fluid F2 may therefore flow through the intake runners 44 and then into the interior volume 48 of each battery module 22 for quickly and efficiently carrying away excessive heat and stabilizing the temperatures of the battery cells 24 and expelling battery vent byproducts V from one or more of the battery modules 22 that are experiencing the battery thermal event.

The exemplary traction battery packs of this disclosure include a thermal management and venting system for providing enhanced battery cell thermal management and vent gas management. The proposed systems and methods are capable of controlling the flow of a cooling fluid throughout the system for more quickly and efficiently reducing temperatures of vent gases and hot particulates by mixing the vent gases with the cooling fluid, thereby substantially eliminating vent gas combustion and thermal propagation during a battery thermal event.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A traction battery pack, comprising:
a first battery module that includes a plurality of battery cells arranged within a first interior volume;
a heat exchanger plate positioned in thermal contact with the plurality of battery cells;
a first intake manifold fluidly connected to the first interior volume;
a second intake manifold fluidly connected to the heat exchanger plate;
a flow control valve configured to selectively control a flow of a cooling fluid to either the first intake manifold or the second intake manifold; and
a control module programmed to control a position of the flow control valve based on a temperature of the cooling fluid exiting the heat exchanger plate.

2. The traction battery pack as recited in claim 1, comprising a second battery module including a second interior volume that is fluidly isolated from the first interior volume.

3. The traction battery pack as recited in claim 2, wherein the first intake manifold is fluidly connected to the second interior volume.

4. The traction battery pack as recited in claim 3, comprising a first intake runner that fluidly connects the first intake manifold to the first interior volume, and further comprising a second intake runner that fluidly connects the first intake manifold to the second interior volume.

5. The traction battery pack as recited in claim 4, comprising a first exhaust manifold fluidly connected to the first interior volume by a first exhaust runner, and further comprising a second exhaust manifold fluidly connected to the second interior volume by a second exhaust runner.

6. The traction battery pack as recited in claim 1, comprising a first intake runner that fluidly connects the first intake manifold to the first interior volume.

7. The traction battery pack as recited in claim 5, comprising a pressure activated valve installed within the first intake runner.

8. The traction battery pack as recited in claim 1, wherein the control module is programmed to command the flow control valve to a first position for directing the flow of the cooling fluid through the second intake manifold and not the first intake manifold when the temperature of the cooling fluid exiting the heat exchanger plate is less than a predefined temperature threshold.

9. The traction battery pack as recited in claim 8, wherein the control module is programmed to command the flow control valve to a second position for directing the flow of the cooling fluid through the first intake manifold and not the second intake manifold when the temperature of the cooling fluid exiting the heat exchanger plate is greater than or equal to the predefined temperature threshold.

10. The traction battery pack as recited in claim 1, wherein the control module is programmed to command the flow control valve to a position for dividing the flow of the cooling fluid between the first intake manifold and the second intake manifold when the temperature of the cooling fluid exiting the heat exchanger plate is greater than or equal to the predefined temperature threshold.

11. The traction battery pack as recited in claim 1, comprising a temperature sensor positioned within or near a cooling fluid outlet of the heat exchanger plate and configured to sense the temperature.

12. The traction battery pack as recited in claim 1, comprising a thermal interface material configured to maintain the thermal contact between the plurality of battery cells and the heat exchanger plate.

13. The traction battery pack as recited in claim 1, comprising a first exhaust manifold fluidly connected to the first interior volume by a first exhaust runner.

14. The traction battery pack as recited in claim 13, wherein the first exhaust manifold is configured to expel the cooling fluid and a battery vent byproduct from the first interior volume during a battery thermal event.

15. The traction battery pack as recited in claim 1, wherein the second intake manifold is fluidly connected to an internal cooling circuit of the heat exchanger plate.

16. A traction battery pack, comprising:
a first battery module that includes a plurality of battery cells arranged within a first interior volume;
a first cooling fluid inlet configured to receive a first cooling fluid;
a first intake manifold fluidly connected to the first interior volume and configured to receive the first cooling fluid from the first cooling fluid inlet;
a second cooling fluid inlet configured to receive a second cooling fluid;
a heat exchanger plate positioned in thermal contact with the plurality of battery cells and configured to receive the second cooling fluid from the second cooling fluid inlet; and
a control module programmed to control a flow of the first cooling fluid from the first cooling fluid inlet into the first intake manifold based on a temperature of the second cooling fluid exiting the heat exchanger plate.

17. The traction battery pack as recited in claim 16, wherein the first cooling fluid is a dielectric fluid and the second cooling fluid is a coolant.

18. The traction battery pack as recited in claim 16, comprising a second battery module including a second interior volume that is fluidly isolated from the first interior volume.

19. The traction battery pack as recited in claim 16, wherein the control module is programmed to command the flow of the first cooling fluid into the first intake manifold when the temperature of the second cooling fluid exiting the heat exchanger plate is greater than or equal to a predefined temperature threshold.

20. The traction battery pack as recited in claim 19, wherein the control module is programmed to prevent the flow of the first cooling fluid into the first intake manifold when the temperature of the second cooling fluid exiting the heat exchanger plate is less than the predefined temperature threshold.
